(19) United States
(12) Patent Application Publication
(10) Pub. No.: US 2019/0001242 A1
(43) Pub. Date: Jan. 3, 2019

(54) FILTER WITH NON-HORIZONTAL CAVITY

(71) Applicant: MOTT CORPORATION, Farmington, CT (US)

(72) Inventors: Matthew C. SIOK, Farmington, CT (US); John E. ROSENBERGER, Plantsville, CT (US); Kenneth L. RUBOW, Avon, CT (US); Allen BEAUNE, Norfolk, CT (US)

(21) Appl. No.: 16/016,744

(22) Filed: Jun. 25, 2018

Related U.S. Application Data
(60) Provisional application No. 62/527,414, filed on Jun. 30, 2017.

(51) Int. Cl. B01D 29/23; B01D 29/15; B01D 29/05; B01D 39/20

(52) U.S. Cl. CPC B01D 29/23; B01D 29/15; B01D 29/05; B01D 2201/347; B01D 39/2041; B01D 2201/287; B01D 2201/30; B01D 39/2031

(57) ABSTRACT

Filters that include non-horizontal filter cavities, such as cavities that are vertically, diagonally, or otherwise non-horizontally with respect to a filter block.

### RELATED APPLICATIONS

The present application claims priority to U.S. Provisional Application Ser. No. 62/527,414, filed on Jun. 30, 2017 and entitled “FILTER WITH NON-HORIZONTAL CAVITY.” The contents of the aforementioned application are incorporated herein by reference.

### TECHNICAL FIELD

Embodiments of the present invention generally relate to fluid flow filters and restrictors.

### BACKGROUND

There are numerous applications requiring a structure that is used for the filtration and/or flow control of fluids, such as gases and liquids. Although conventional techniques have successfully manufactured and used structures for flow control and filtration applications, the porosity and other structural properties of the resultant products may be limited. For example, conventional structures often plug quickly and are consequently ineffective. Additionally, conventional structures may result in a limited flow rate for a given pore size required for predetermined filtration specifications. There is therefore a need for filtration devices, flow control devices, drug delivery devices and similar devices that have novel, precise and controllable fluid flow and filtration characteristics. Additionally, a need exists for structures and methods of manufacture that more reliably produce structures for high-purity filters and flow devices.

### SUMMARY

In one aspect, the present invention provides filters that include non-horizontal filter cavities, such as cavities that are vertically, diagonally, or otherwise non-horizontally with respect to a filter block.

In another aspect, the present invention provides filters that include porous metal filter elements that are positioned within non-horizontal filter cavities.

In preferred embodiments, filters of the present invention are used as so-called sandwich filters in that they may optionally be placed between fluid handling components, and fluid is transferred between those components by movement through the filters.

In some embodiments of the present invention, a filter block comprises an inlet port and an outlet port connected to the inlet port by a flow passage. The filter block also comprises a filter cavity within a flow passage between the inlet port and outlet port. The filter cavity is oriented in a generally vertical direction. The filter block

comprises a filter element within the filter cavity. In one embodiment, the flow passage directs a fluid from the inlet port to the filter cavity, in which it is filtered by a filter element. The fluid thereafter exits the filter cavity via an outlet port.

In other embodiments of the present invention, a filter block comprises an inlet port in the filter block and an outlet port connected to the inlet port by a flow passage. The filter block further comprises a filter cavity within a flow passage between the inlet port and outlet port. The filter cavity is oriented in a diagonal direction. The filter block comprises a filter element within the filter cavity.

### BRIEF DESCRIPTION OF THE DRAWINGS

FIG. 1A illustrates a pressed gasket filter element inserted into the generally vertical filter cavity, in accordance with an embodiment of the present invention.

FIG. 1B illustrates a filter element and an adapter inside a generally vertical filter cavity, in accordance with an embodiment of the present invention.

FIG. 2A illustrates a cross section of the filter cavity in a generally vertical direction in a filter block, in accordance with an embodiment of the present invention.

FIG. 2B illustrates a filter element within the generally vertical filter cavity, in accordance with an embodiment of the present invention.

FIG. 2C illustrates a three dimensional representation of a filter block, in accordance with an embodiment of the present invention.

FIG. 2D illustrates a cross section view of the filter block, in accordance with an embodiment of the present invention.

FIG. 2E illustrates a three dimensional representation of a filter block, in accordance with an embodiment of the present invention.

FIG. 2F illustrates a cross section view of a filter block, in accordance with an embodiment of the present invention.

FIG. 2G illustrates a filter element within the generally vertical filter cavity and a flow passage, in accordance with an embodiment of the present invention.

FIG. 3 illustrates a filter cavity oriented diagonally from a corner of the filter block, in accordance with an embodiment of the present invention.

### DETAILED DESCRIPTION OF THE PREFERRED EMBODIMENTS

The present invention filter elements, designs and assemblies that can be used in filtration devices, flow control devices, semiconductor operations, drug delivery devices and similar devices that are used for, or in conjunction with, the controlled flow of fluids (e.g., gases and liquids) there through.

Generally, the filter described herein, when used in accordance with the present invention, results in high purity fluids which are infrequently plugged by particulates. In an embodiment, the present invention includes a filter block with ports and a generally vertical or diagonal filter cavity with a filter element inside the cavity. A flow passage sends the fluid into a port of the filter block. The fluid enters the filter cavity and impurities, contaminates and particulates are filtered out through the filter element within the filter cavity. In one embodiment, the flow passage of the fluid inside the cavity is created by a high pressure air stream.

In one embodiment, a filter cavity is located within a filter block. The filter cavity includes a filter element, an adapter and/or a seal. The seal may include, but is not limited to, a gasket. The filter provides leak-proof performance at high temperatures and pressures. In one embodiment, the filter is leak-proof up to temperatures of about 460° C.

In one embodiment, the filter is an integrated gas system filter. The filter includes one or more porous metal elements. In one embodiment, the filter is used for semiconductor manufacturing. The filter can filter particles down to 0.0015 μm. In an embodiment, the filter may comprise 316L Stainless Steel, Hastelloy® (Haynes Stellite Company, Kokomo, Ind.) C-22 PENTA Nickel® and/or 316L Stainless Steel or Hastelloy C-22 fiber.

Filters of the present invention provide efficient particle capture in order to create fluids that are free from impurities, contaminant and particulates. Moreover, filters of the present invention minimize the length of the filter block while minimizing the total surface area.

The filters of the present invention make use of porous metallic filter elements that are made from metal particles and metal fiber. In the context of the manufacturing of filter elements used in the present invention, “particulate,” “particles,” and “powder” are used synonymously to mean particles that are sized on the order of millimeters, micrometers or nanometers, and have any suitable shape such as spherical, substantially spherical (e.g., having an aspect ratio greater than 0.6, 0.7 or 0.8) and irregular, and mixtures thereof. A preferred particle size range for use in the present invention is less than 2 to 500 micrometers. Metal fiber can be as small as 1 micrometer diameter. Preferred materials for use in the present invention include materials such as, for example, nickel, cobalt, iron, copper, aluminum, palladium, titanium, tungsten, platinum, silver, gold, and alloys and oxides thereof including stainless steels and nickel-based steels such as Hastelloy® (Haynes Stellite Company, Kokomo, Ind.). Various polymer materials may also be used.

### EXAMPLES

The present invention is further described with reference to the following non-limiting examples.

### Example 1—A Pressed Gasket Filter

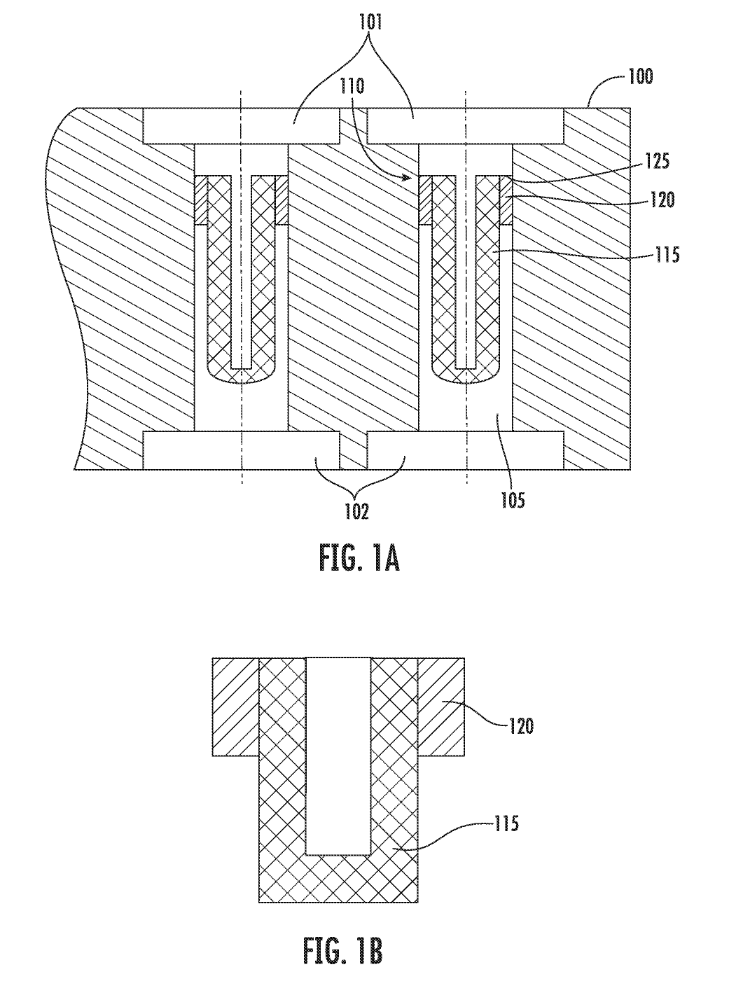

FIG. 1A illustrates a pressed gasket filter element inserted into a generally vertical filter cavity, in accordance with an embodiment of the present invention. In one embodiment, a filter block 100 is located between two substrates. In an alternate embodiment, the filter block 100 is a standalone filter. The filter block 100 comprises a durable, temperature resistant and corrosion resistant material, such as stainless steel, Hastelloy®, Monel®, Inconel®, nickel and/or titanium. The inside of the filter block 100 includes flow passages, cavities and/or holes.

According to FIG. 1A, the filter block 100 includes one or more ports 101, 102 that act as inlets and/or outlets for fluid (i.e., gas or liquid). Flow passages are used within the filter block 100 to lead the fluid from an inlet port 102, through a generally vertical filter cavity 105, and out an outlet port 102. The fluid flows into a first port 101 and through a flow passage into a generally vertical filter cavity 105. The filter block 100 includes dual generally vertical cavities 105. In an alternate embodiment, the filter block 100 includes only a single cavity oriented in a generally vertical direction. In yet other alternate embodiments, the filter block 100 includes three or more generally vertical cavities.

In one embodiment, the inlet/outlet ports 101, 102 intersect a solid material surface to enable interfacing the ports of the filter block 100 to other hardware. The one or more cavities and the one or more ports 101, 102 are machined into the filter block 100 using known machining techniques.

FIG. 1A shows a filter block 100 where both generally vertical filter cavities 105 include the same pressed gasket filters 110. The gasket filter 110 may be inserted into only one or both vertical cavities 105. A benefit of dual filters is that they provide a decreased pressure drop in comparison to a single filter. In an embodiment, the dual filters are configured for an outlet side of the filter block 100. In an alternate embodiment, the dual filters are configured for an inlet side of the filter block. In yet another alternate embodiment, a first filter is configured for the inlet side while the second filter is configured for the outlet side of the filter block.

In an embodiment, the filter used in the present invention is between 0.5 and 2 inches in height. In an embodiment, the filter used in the present invention is capable of operating up to a maximum fluid temperature of 460° C. In an alternate embodiment, the maximum operating temperature may be 460° C. for an inert gas.

The pressed gasket filter 110 in FIG. 1A includes a filter element 115, an adapter 120 and a gasket 125. In one embodiment, a gasket 125 forms a seal between the filter element 115, adapter 120 and the filter cavity 105. The filter element 115, the adapter 120 and the gasket 125 of the pressed gasket filter 110 separate the generally vertical filter cavity 105 into two areas in order to filter the fluid. The filter cavity 105 separates the filtered fluid from the unfiltered fluid which contains impurities, particulates and contaminates. In one embodiment, the fluid flows from a first port 101 into the pressed gasket filter 110 in the filter cavity 105. By pushing the fluid through the pressed gasket filter 110, the fluid is filtered such that one area of the filter cavity 105 includes the filtered fluid while the other area of the filter cavity contains the impurities, contaminates and particulates. The filtered fluid leaves the fluid cavity and flows out the second port.

As can be seen in FIG. 1A, the filter element 115 comprises a generally tubular shape. The filter element 115 may include a filter sheet, a filter disk, a filter cup or other configuration. The filter element 115 comprises, but is not limited to, stainless steel, Hastelloy®, Monel®, Inconel®, nickel and/or titanium. In FIG. 1A, the filter element 115 is coupled to an adapter 120. In one embodiment, the filter element 115 is welded to the adapter 120. The adapter 120 comprises stainless steel, nickel and/or other material. The radius or outer dimension of the adapter 120 is larger than the filter element 115 so as to surround the filter element 115.

In FIG. 1A, the gasket 125 fits within the filter cavity 105. The gasket 125 seals the filter element 115 and the adapter 120 to the filter cavity. The gasket 125 is compatible with most inert and specialty fluids. The gasket is an all-metal, all-welded design with no particulate shedding. In an embodiment, the gasket 125 comprises nickel and/or 316L stainless steel. In one embodiment, the gasket 125 fits inside ¼″ and ½″ face seal fittings of the generally vertical filter cavity 105. According to FIG. 1, the radius of the exterior edge of the gasket 125 is just smaller than the filter cavity 105 so as to fit inside the cavity. However, the gasket 125 is large enough to seal the filter cavity. In an alternate embodiment, the gasket 125 has the same radius or outer dimension as the filter cavity 105. In one embodiment, the gasket 125 sits on top of the generally vertical filter cavity 105 in order to seal the filter element 115 and the adapter 120 to the filter cavity 105.

According to FIG. 1A, fluid flows from the first port 101 through the pressed gasket filter 110 into a first area of the generally vertical filter cavity 105. More specifically, the fluid flows through the adapter 120 and permeates the filter element 115. In an embodiment, the fluid flows through the center of the adapter 120 and into the filter element 115. The filter element 115 filters and removes the particulates, contaminates and impurities in the fluid. The filtered fluid flows into a second area of the filter cavity 105 and leaves through the second port 102.

FIG. 1B illustrates a filter element and an adapter inside the generally vertical filter cavity, in accordance with an embodiment of the present invention. The filter element 115 may include a filter tube as depicted in FIG. 1A. In an alternate embodiment, the filter element 115 comprises a disk, sheet, cup or other type of filter. The filter element 115 may include, but is not limited to, stainless steel, Hastelloy®, Monel®, Inconel®, nickel and/or titanium. The filter element 115 is connected to an adapter 120. The adapter 120 may be the same as the adapter as described in FIG. 1A. The adapter 120 can be stainless steel, nickel or other material. In one embodiment, the filter element 115 is connected to the adapter 120 via welding. As shown in FIG. 1B, the adapter 120 surrounds the filter element 115.

### Example 2—Top-Concept Filter

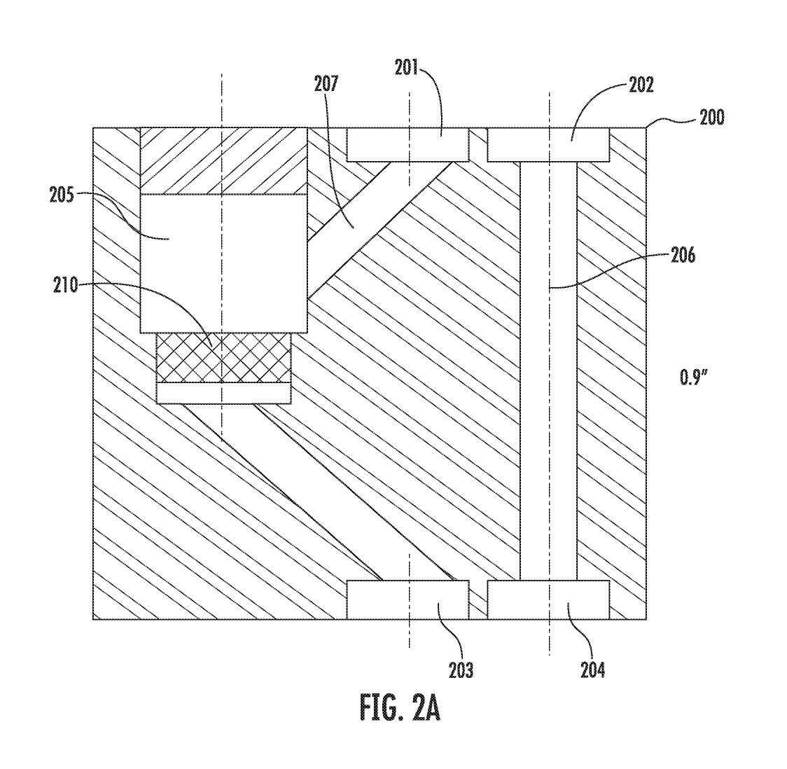

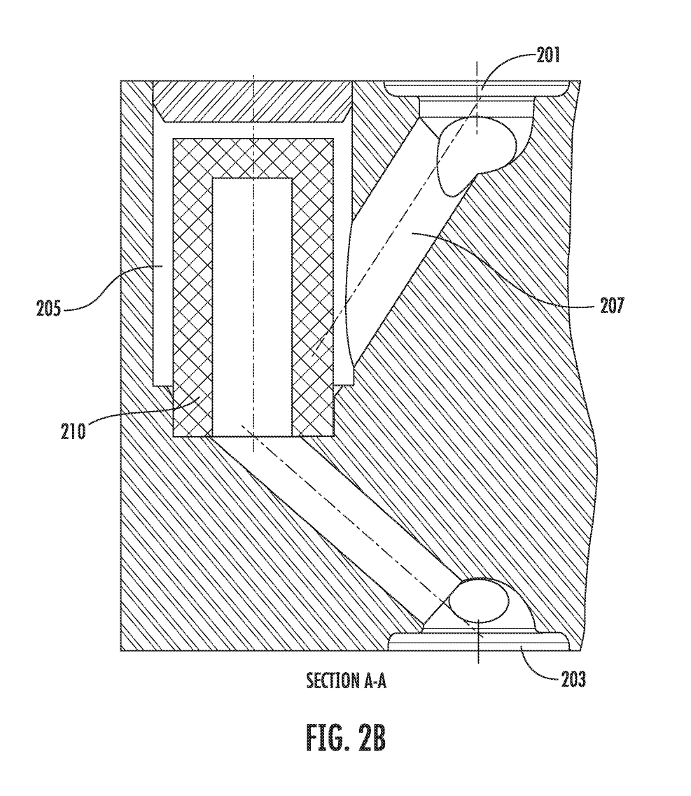

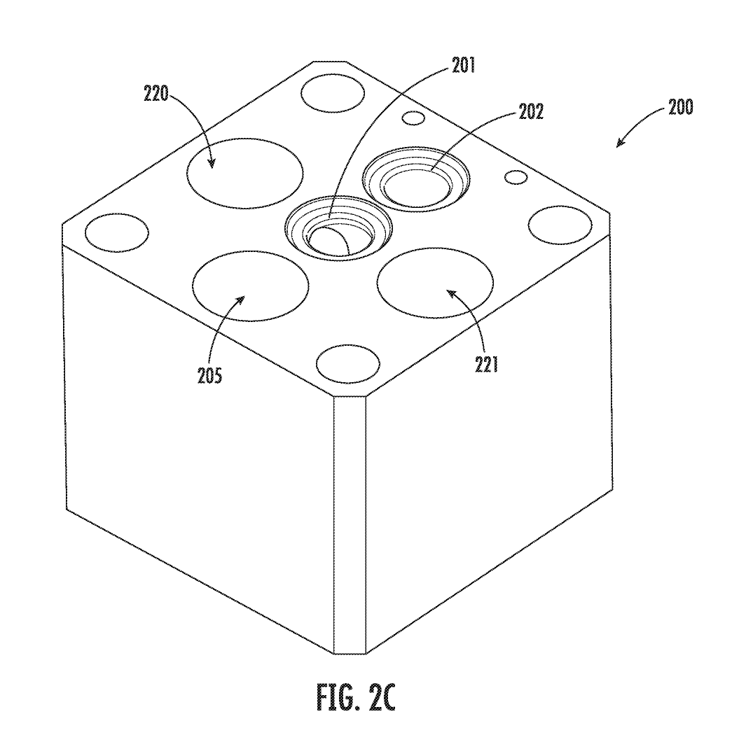

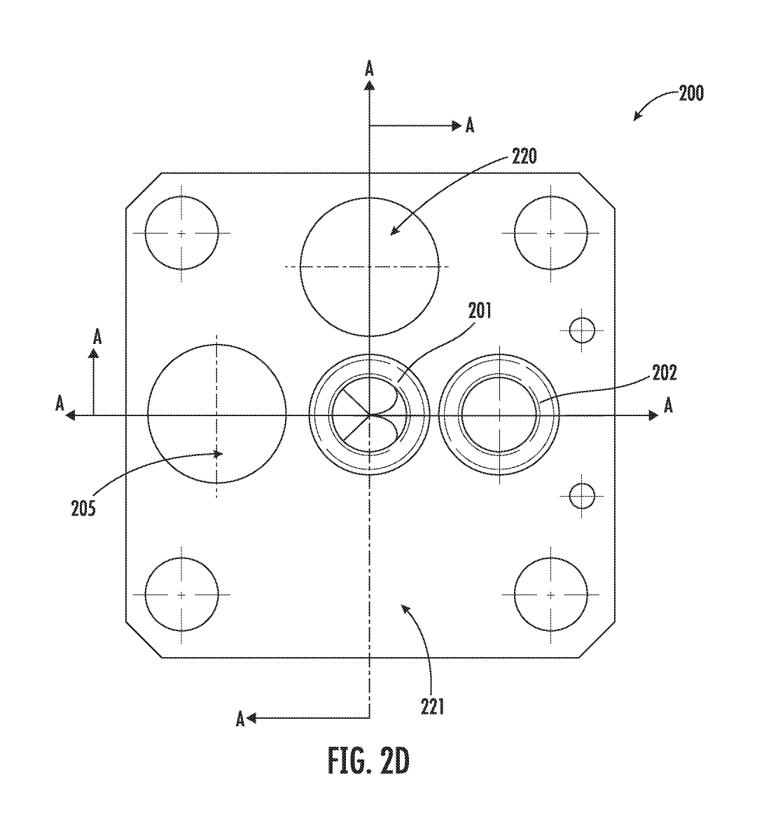

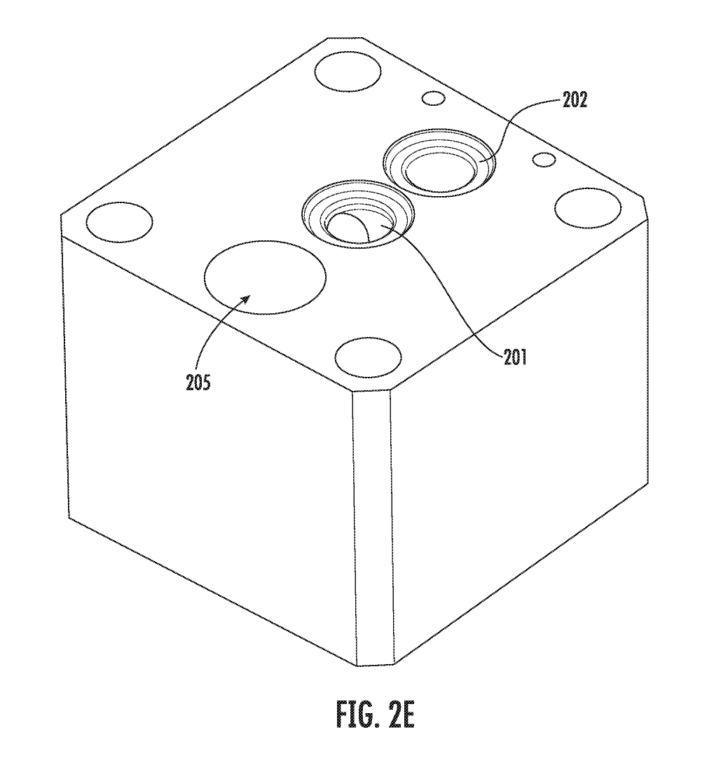

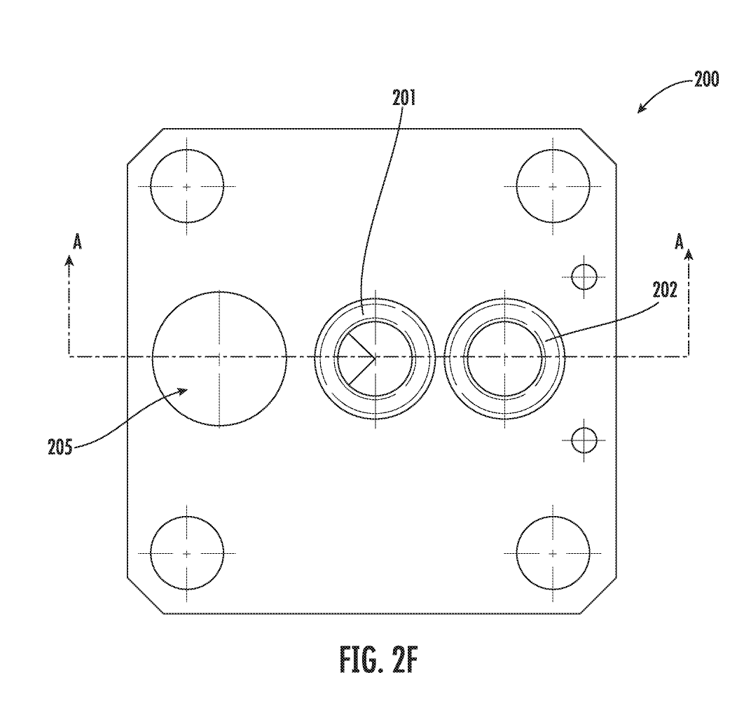

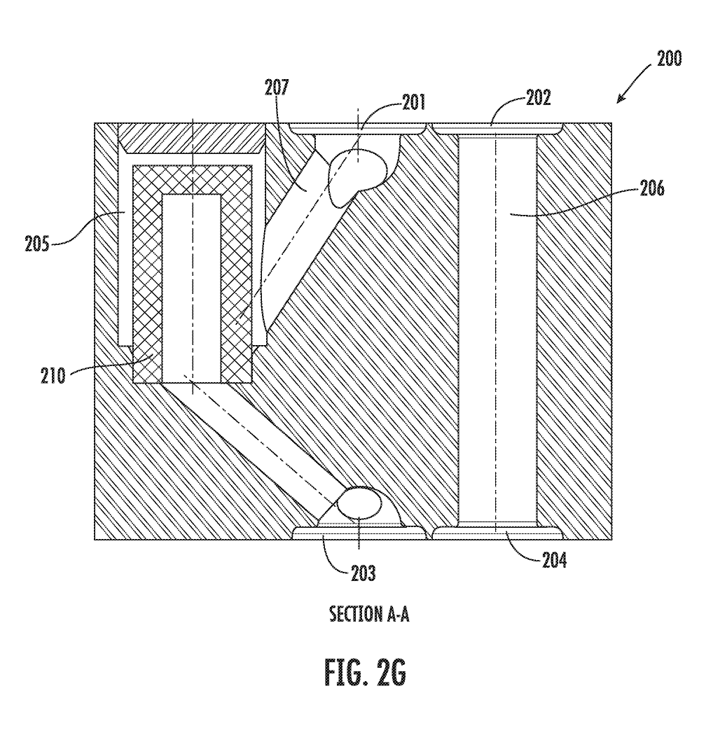

FIG. 2A illustrates a cross section of a filter cavity in a generally vertical direction in a filter block, in accordance with an embodiment of the present invention. The filter element 210 inside the filter cavity 205 may be oriented in either a horizontal or vertical direction. FIG. 2A shows an image of the filter element 210 oriented horizontally within the generally vertical filter block 200 of the present invention.

In one embodiment, the filter block 200 is located between two substrates. In an alternate embodiment, the filter block 200 is a standalone filter. The filter block 200 comprises a durable, temperature resistant and corrosion resistant material such as stainless steel, Hastelloy®, Monel®, Inconel®, nickel and titanium.

According to FIG. 2A, the filter block 200 may include one or more generally vertical cavities and/or flow passages. A flow passage moves fluid between inlet ports and outlet ports in the filter block. FIG. 2A depicts a filter cavity 205 and flow passages 206 and 207. The filter cavity 205 is oriented in a vertical orientation in the filter block 200. The flow passage 206 is oriented in a generally vertical direction in the filter block 200. The flow passage 207 is oriented in diagonal directions in the filter block 200. In alternate embodiments, there may be more or less flow passages and/or filter cavities in the filter block 200.

The filter block 200 includes one or more ports 201, 202, 203, 204 for the fluid to enter and exit. A generally vertical flow passage 206 is formed between port 202 and port 204. In one embodiment, the fluid may flow from the inlet port 202 through the flow passage and out of the outlet port 204. The inlet/outlet ports are a solid material to enable the ports 201, 202, 203, 204 of the filter block 200 to interface with other hardware. However, the inside of the filter block 200 includes one or more cavities or flow passages and porous material. In one embodiment, the one or more cavities, flow passages and ports are machined into the filter block 200 using known machining techniques.

In one embodiment, the distance from the top of the inlet port 201, 202 in the filter block 200 to the bottom outlet port 203, 204 in the filter block is less than an inch, such as about 0.9 inches. In an alternate embodiment, the distance may be between 0.8 inches to 1 inch in length. The small size of the filter block 200 allows for less space being consumed on a gas stick containing all the other gas handling components.

As shown in FIG. 2A, the flow passage 207 from input port 201 to output port 203 is separated into two sections or areas by the filter cavity 205. In one embodiment, the first area of the flow passage 207 has the fluid flowing diagonally from top right to bottom left. The second area of the flow passage 207 has the fluid flow diagonally from top left to bottom right. Alternatively, the first area could have the fluid flow diagonally from top left to bottom right and the second area could have the fluid flow diagonally from top right to bottom left.

FIG. 2A depicts the first section of the flow path 207 oriented in a diagonal manner such that the fluid flows diagonally down from the port 201 to the filter cavity 205. The filter element 210 in the filter cavity 205 separates the filtered fluid from the unfiltered fluid. The unfiltered fluid contains impurities, contaminates and particulates. In one embodiment, the fluid flows from an inlet port 201 diagonally through the flow passage 207 into the filter cavity 205 and through the filter element 210. By pushing the fluid through the filter element 210, the fluid is filtered and the impurities, contaminates and particulates remain behind while the filtered fluid flows in a different diagonal direction down through the flow passage 207 and out an outlet port 203.

Filter cavity 205 comprises a porous filter element 210. The filter element 210 may include a variety of differently shaped filters. The filter element 210 may include, but is not limited to, a filter tube, a filter disk and/or a filter cup. A filter element 210 may comprise a material such as stainless steel, Hastelloy®, Monel®, Inconel®, nickel and/or titanium.

FIG. 2A illustrates the filter element 210 inserted into the filter cavity 205 in a horizontal orientation. FIG. 2B illustrates the filter element 210 inserted into the filter cavity 205 in a vertical orientation. In FIG. 2B, the filter element 210 is in the shape of a filter cup. In either embodiment, the filter element 210 separates out the impurities, contaminates and particulates in the fluid so that only the filtered fluid flows through to the other side of the flow passage 207 and out of the outlet port 203.

In addition to the filter element 210, an adapter may be included in the filter cavity 205. The adapter comprises stainless steel, nickel and/or other suitable material. In one embodiment, the filter element 210 is connected to the adapter via welding. In one embodiment, the adapter is larger than the filter element 210 and surrounds the filter element 210. In an alternate embodiment, the adapter is the same size as the other filter element 210.

The filter cavity 205 may include a sealing mechanism. Although not pictured in FIG. 2A, a sealing mechanism seals the filter element and/or adapter to the filter cavity. The sealing mechanism may include, but is not limited to, a gasket that is compatible with most inert and specialty fluids. In certain embodiments, the gasket comprises an all-metal, all-welded design with no particulate shedding. In an embodiment, the gasket comprises nickel and/or 316L stainless steel. In one embodiment, the gasket sits on top of the filter cavity 205 in order to seal the filter element 210 to the filter cavity 205.

In FIG. 2A, fluid flows from an inlet port 201 through a first diagonal area of the flow passage 207 into the filter cavity 205. In one embodiment, the filter element 210 comprises a filter tube. As shown in FIG. 2A, the filter element 210 is oriented generally horizontally. Alternatively, FIG. 2B depicts the filter element 210 as oriented generally vertically as a filter cup. Regardless of whether the filter element 210 is oriented in a horizontal or vertical direction, the particulates, contaminates and impurities are filtered out of the fluid though the porous filter element 210. The filtered fluid flows out of the filtered element 210, into a second area of the flow passage 207 and out of an outlet port 203.

FIG. 2C illustrates a three dimensional representation of a filter block 200. The filter block 200 includes one or more cavities with one or more filter elements 210 inserted into the filter block. 200. FIG. 2C is the three dimensional representation of the section A-A view in FIG. 2B. FIG. 2C illustrates the exterior of filter block 200. In FIG. 2C, filter element 210 is inserted into the filter block 200. FIG. 2C includes ports 201 and 202 which each have flow passages in the filter block. FIG. 2C includes three flow passages and cavities 205, 220 and 221 within the filter block 200. The filter block 200 may include more or fewer cavities and air flow passages. In various embodiments, one, two or three filter elements 210 may be inserted into the filter 200 and intersect with the air flow passages and cavities.

FIG. 2D illustrates a cross section view of the filter block 200. FIG. 2D illustrates the ports 201 and 202 along with the other flow passages and cavities 205, 220, 221. The flow passage 207 from port 201 intersects with the cavity 205 and filter element 210 as shown in FIG. 2B. FIG. 2B is a cut into the filter block 200 from the section A-A view of FIG. 2D.

FIG. 2B illustrates a cavity 205 with filter 210 inserted into the filter block 200. The cavity 205 and filter 210 may intersect the air flow passage 207 between port 201 and port 203. As discussed above, FIG. 2B illustrates that the filter element 210 is a filter cup. In FIG. 2B, the fluid flows from an inlet port 201 through a first diagonal area of the flow passage 207 into the filter cavity 205 with filter element 210. The particulates, contaminates and impurities are filtered out of the fluid though the porous filter element 210. The filtered fluid flows out of the filtered element 210, into a second area of the flow passage 207 and out of an outlet port 203.

In another embodiment, FIG. 2E illustrates a three dimensional representation of a filter block 200. FIG. 2E illustrates the exterior of the filter block 200. In FIG. 2E, filter element 210 is inserted into the filter block 200. FIG. 2E includes ports 201 and 202 which each have flow passages in the filter block. FIG. 2E includes cavity 205 which includes the filter element 210. The filter block 200 may include more or fewer cavities and air flow passages and one or more filter elements 210.

FIG. 2F illustrates a cross section view of the filter block 200 in FIG. 2E. FIG. 2F illustrates the ports 201 and 202 along with the flow passages and cavity 205. The flow passages from ports 201 and 202 are shown in the interior of the filter block in FIG. 2G. FIG. 2G is a cut into the filter clock 200 from the section A-A view from FIG. 2F. The flow passage 207 from port 201 intersects with the cavity 205 and filter element 210. The fluid is filtered in the filter cavity 205 with filter element 210. Filter element 210 is a longitudinal filter cup filter. The filter element 201 filters the fluid and the filtered fluid flows through the rest of the flow passage 207 and out port 203.

FIG. 2G illustrates a filter element 210 within the generally vertical filter cavity 205 and flow passages 206, 207. FIG. 2G shows port 202 with flow passage 206 and an exit port 204. The flow passage 206 in FIG. 2G does not have a filter element inserted or intersect with a filter element. However, by having flow passage 206 in filter block 100, additional filter surface area is created which accommodates more fluid to flow through the filter block 200. The additional filter surface area from the flow passage 206 increase the flow rate through the filter block 200.

As shown in FIG. 2A-G, inserting the filter element 210 into the filter block 200 is advantageous as it provides an efficient form of particulate capture and minimizes the length of the filter block. Furthermore, the filter element 210 minimizes the total surface area necessary for filtering the fluid.

### Example 3—Corner Diagonal Filter

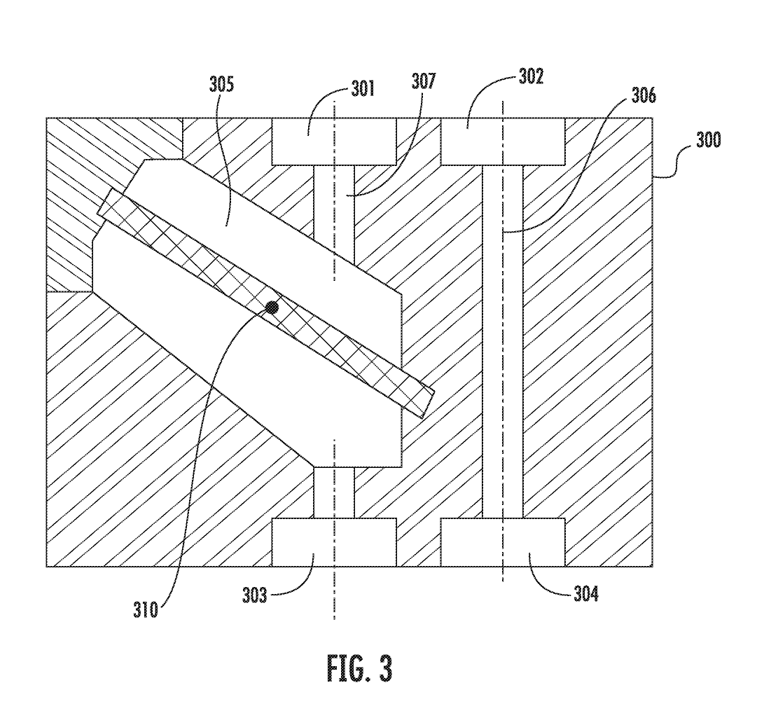

FIG. 3 illustrates a filter cavity inserted diagonally from a corner of the filter block, in accordance with an embodiment of the present invention. The present invention includes a filter cavity 305 with filter element 310 inserted into a filter block 300. The filter cavity 305 with the filter element 310 may be oriented diagonally in either an upper left to lower right direction or an upper right to a lower left direction within the filter block 300. FIG. 3 shows an image of the filter cavity 305 with the filter element 310 oriented from an upper left to lower right direction within the filter block 300.

In one embodiment, the filter block 300 is located between two substrates as a sandwich. In an alternate embodiment, the filter block 300 is a stand-alone filter. The filter block 300 is made of a durable, temperature resistant, corrosion resistant material such as stainless steel, Hastelloy®, Monel®, Inconel®, nickel and titanium.

According to FIG. 3, the filter block 300 includes one or more flow passages 306, 307 created between inlet ports 301, 302 and outlet ports 303, 304. FIG. 3 depicts the two flow passages 306, 307 oriented in generally vertical directions. However, the filter block 300 can include a single flow passage or three or more flow passages. In FIG. 3, filtered cavity 305 is inserted in a diagonal direction into the filter block 300 and into flow path 307.

The filter block 300 includes one or more ports 301, 302, 303, 304 for the fluid to enter and exit. Generally vertical flow passages are formed between port 301 and port 303 and between port 302 and 304. In one embodiment, fluid may flow from inlet ports 301, 302 through generally vertical flow passages 306, 307 and out of the outlet ports 303, 304. The inlet/outlet ports comprise a solid material to enable the ports 301, 302, 303, 304 of the filter block 300 to interface with other hardware. In one embodiment, the one or more ports 301, 302, 303, 304 are machined into the filter block 300 using known machining techniques.

FIG. 3 depicts the filter cavity 305 with the filter element 310 inserted into the filter block 300 in a diagonal orientation. In an embodiment, the filter cavity 305 may be inserted diagonally from top right to bottom left from the corner of the filter block 300. In an alternate embodiment, the filter cavity 305 with the filter element 310 may be inserted in a diagonal orientation from top left to bottom right.

The filter element 310 is porous. The filter element 310 includes a variety of differently shaped filters. The filter element 310 may include, but are not limited to, a filter tube, a filter disk and/or a filter cup. A filter element 310 comprises, but is not limited to, stainless steel, Hastelloy®, Monel®, Inconel®, nickel and/or titanium.

The filter element 310 separates the filtered fluid from the unfiltered fluid within the flow passage 307. In one embodiment, the fluid flows from an inlet port 301 and into the flow passage 307. The filter element 310 in the filter cavity 305 separates the flow passage 307 into two sections or areas so that the particulates and impurities are stopped by the filter element 310. By pushing the fluid through the filter element 310, the fluid is filtered and the impurities, contaminates and particulates remain behind. Only the filtered fluid flows out of the filtered cavity 305, into a second area of the flow passage 307 and out the outlet port 303.

In an embodiment, the filter element 310 may be connected to an adapter. The adapter comprises stainless steel, nickel and/or other material. In one embodiment, the filter element 310 is connected to the adapter via welding. In an embodiment, the adapter is larger than the filter element 310 and surrounds the filter element 310. In an alternate embodiment, the adapter is the same size as the filter element 310.

In one embodiment, the filter element 310 and/or adapter are connected to a sealing mechanism. The sealing mechanism seals the filter element 310 and/or adapter to the filter cavity 305. The sealing mechanism may include, but is not limited to, a gasket. In one embodiment, the gasket sits over the filter cavity 305 in order to seal the filter element 310 to the filter cavity 305.

According to FIG. 3, the fluid flows from an inlet port 301 through the flow passage 307 and into filter cavity 305 with filter element 310. FIG. 3 depicts the filter element 310 as a filter tube. The filter cavity 305 with the filter element 310 is inserted in a generally diagonal orientation into a filter block 300. The particulates, contaminates and impurities are filtered out of the fluid though the porous filter element 310 in the filter cavity 305. The filtered fluid flows out of the filtered cavity, into the flow passage 307 and out of an outlet port 303.

In an embodiment, one, two, three or more filter cavities 305 with the filter elements 310 may be diagonally inserted into parallel flow passages 306, 307 within the filter block 300. For example, a second filter cavity 305 with a filter element 310 could be inserted into the flow passage 306 between inlet port 302 and outlet port 304. In one example, three filter cavities 305 with filter elements 310 may be inserted into three parallel vertical flow passages. In another example, a filter tube 310 with the filter cavity 305 may be inserted into a single vertical cavity in the filter block as shown in FIG. 3.

Diagonally inserting the filter cavity 305 with the filter element 310 into the filter block 300 provides an efficient form of particulate capture and minimizes the length of the filter block 300. By allowing the filter cavity 305 with the filter element 310 to be inserted in a diagonal direction, the overall size of the filter block 300 is decreased. Diagonally inserting the filter cavity 305 with filter element 310 also minimizes the total surface area necessary for filtering the fluid.

Certain embodiments of the present invention are described above. It is, however, expressly noted that the present invention is not limited to those embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the present invention. As such, the invention is not to be defined only by the preceding illustrative description and examples.

1. A filter block comprising:
a first exterior surface and a second exterior surface;
a first inlet port in the first exterior surface;
a first outlet port in the second exterior surface;
a first filter cavity extending between the first inlet port and the first outlet port, wherein the first filter cavity is oriented in a generally non-horizontal direction when in use; and
a first filter element within the first filter cavity.

2. The filter block of claim 1, further comprising a second inlet port in the first exterior surface, a second outlet port in the second exterior surface, and a second filter cavity extending between the second inlet port and the second outlet port, wherein the second filter cavity is oriented in a generally non-horizontal direction when in use.

3. The filter block of claim 2, further comprising a second filter element within the second filter cavity.

4. The filter block of claim 1, wherein the first filter cavity is oriented in a generally vertical direction when in use.

5. The filter block of claim 1, wherein the first filter is characterized by a height of between 0.5 inches and 2 inches.

6. The filter block of claim 1, wherein the first filter element comprises a metallic material.

7. The filter block of claim 6, further comprising a gasket that forms a seal between the first filter element and the first filter cavity.

8. The filter block of claim 7, wherein the gasket comprises a metallic material.

9. The filter block of claim 8, wherein the filter element is a filter tube.

10. The filter block of claim 1, wherein the filter element is in the shape of a cup.

11. The filter block of claim 1, wherein the first filter element is oriented in a generally horizontal direction when in use.

12. The filter block of claim 1, wherein the first filter cavity is oriented in a vertical direction when in use.

13. The filter block of claim 1, wherein the first filter cavity is oriented in a diagonal direction when in use.

14. A filter block comprising:
an inlet port;
an outlet port connected to the inlet port by a flow passage;
a filter cavity within a flow passage between the inlet port and outlet port, wherein the filter cavity is oriented in a vertical direction when in use; and
a filter element within the filter cavity.

15. A filter block comprising:
an inlet port;
an outlet port connected to the inlet port by a flow passage;
a filter cavity within a flow passage between the inlet port and outlet port, wherein the filter cavity is oriented in a diagonal direction when in use; and
a filter element within the filter cavity.
